(19) United States
(12) Patent Application Publication
(10) Pub. No.: US 2025/0264272 A1
(43) Pub. Date: Aug. 21, 2025

(54) REFRIGERATOR, SERVER AND METHOD FOR CONTROLLING REFRIGERATOR

(71) Applicant: Samsung Electronics Co., Ltd., Suwon-si (KR)

(72) Inventors: Hoyoung MAENG, Suwon-si (KR); Junghye KANG, Suwon-si (KR); Doyoon KIM, Suwon-si (KR); Yonghan KIM, Suwon-si (KR); Kookjeong SEO, Suwon-si (KR); Jinkyu SEON, Suwon-si (KR); Sangyoung SO, Suwon-si (KR)

(21) Appl. No.: 19/202,633

(22) Filed: May 8, 2025

Related U.S. Application Data
(63) Continuation of application No. PCT/KR2023/019799, filed on Dec. 4, 2023.

(30) Foreign Application Priority Data
Jan. 12, 2023 (KR) 10-2023-0004992
Feb. 3, 2023 (KR) 10-2023-0014839

(51) Int. Cl. F25D 29/00; F25D 23/02

(52) U.S. Cl. CPC F25D 29/008; F25D 23/028; F25D 2400/02; F25D 2400/34; F25D 2600/02; F25D 2700/06

(57) ABSTRACT

A refrigerator is provided. The refrigerator includes a main body, at least one door provided on a front surface of the main body, a plurality of storage rooms provided on the main body or the at least one door and configured to store articles, a cooling device configured to cool the plurality of storage rooms, a user interface configured to receive a user input from a user or output information to the user, a communication module configured to communicate with a server and a user device, memory storing one or more computer programs, and one or more processors communicatively coupled to the user interface, the communication module, and the memory, wherein the one or more computer programs include computer-executable instructions that, when executed by the one or more processors individually or collectively, cause the refrigerator to control a temperature of the storage room where a purchased article is stored based on product information of the purchased article received from the server and an estimated consumption date of the purchased article input from the user interface or the user device.

### CROSS-REFERENCE TO RELATED APPLICATION(S)

This application is a continuation application, claiming priority under 35 U.S.C. § 365(c), of an International application No. PCT/KR2023/019799, filed on Dec. 4, 2023, which is based on and claims the benefit of a Korean patent application number 10-2023-0004992, filed on Jan. 12, 2023, in the Korean Intellectual Property Office, and of a Korean patent application number 10-2023-0014839, filed on Feb. 3, 2023, in the Korean Intellectual Property Office, the disclosure of each of which is incorporated by reference herein in its entirety.

### BACKGROUND

### 1. Field

The disclosure relates to a refrigerator, a server that manages the refrigerator, and a method for controlling the refrigerator.

### 2. Description of Related Art

A refrigerator is a device for storing stored articles, such as food and beverages, for long-term period without causing spoilage, and the refrigerator is typically provided with a refrigerating compartment for storing the stored articles in a refrigerated state and a freezing compartment for storing the stored articles in a frozen state.

Such a refrigerator performs a cooling cycle of compression, condensation, expansion, and evaporation of the refrigerant repeatedly to maintain the temperature of the storage room at a set target temperature. For example, the refrigerator supplies air cooled by the evaporator provided corresponding to each storage room based on the target temperature of each storage room to each storage room, so that the temperature of the storage room is maintained at the target temperature. Further, the evaporator evaporates the refrigerant to cool the storage room, during which process frost forms on the evaporator. A defrost heater is provided in the refrigerator to remove the frost that has accumulated on the evaporator.

In addition, the refrigerator performs a food management function by displaying information of food stored in the storage room at the request of a user, managing the expiration dates of each food, and providing a warning to the user in case that any food has passed its expiration date.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a refrigerator, a server, and a method for controlling the refrigerator, which are capable of controlling the temperature of the refrigerator based on product information of a purchased article and an estimated consumption date of the purchased article.

Additional aspects will be set forth in part in the description which follows and, in part, will be apparent from the description, or may be learned by practice of the presented embodiments.

In accordance with an aspect of the disclosure, a refrigerator is provided. The refrigerator includes a main body, at least one door provided on a front surface of the main body, a plurality of storage rooms provided on the main body or the at least one door and configured to store articles, a cooling device configured to cool the plurality of storage rooms, a user interface configured to receive a user input from a user or output information to the user, a communication module configured to communicate with a server and a user device, and memory storing one or more computer programs, one or more processors communicatively coupled to the user interface, the communication module, and the memory, wherein the one or more computer programs include computer-executable instructions that, when executed by the one or more processors individually or collectively, cause the refrigerator to control a temperature of a storage room where a purchased article is stored based on product information of the purchased article received from the server and an estimated consumption date of the purchased article input from the user interface or the user device.

In accordance with another aspect of the disclosure, a server is provided. The server includes a communication module configured to communicate with a refrigerator and a user device, memory storing one or more computer programs, and one or more processors communicatively coupled to the communication module and the memory, wherein the one or more computer programs include computer-executable instructions that, when executed by the one or more processors individually or collectively, cause the server to determine a temperature of a storage room where a purchased article is stored based on product information of the purchased article and an estimated consumption date of the purchased article received from the refrigerator or the user device, and control the communication module to transmit a signal to control the temperature of the storage room where the purchased article is stored to the determined temperature of the storage room to the refrigerator.

In accordance with another aspect of the disclosure, a method for controlling a refrigerator, which includes a plurality of storage rooms and a communication module that communicates with a server, is provided. The method includes receiving product information of a purchased article from the server, receiving an estimated consumption date of the purchased article from a user, and controlling a temperature of the storage room where the purchased article is stored based on the product information of the purchased article and the estimated consumption date.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating communication between a household appliance, a server, and a user device according to an embodiment of the disclosure;

FIG. 2 is an exterior view of a refrigerator with a door closed according to an embodiment of the disclosure;

FIG. 3 is an exterior view of a refrigerator with a door open according to an embodiment of the disclosure;

FIG. 4 is a schematic cross-sectional view illustrating a spatial partition of a refrigerator according to an embodiment of the disclosure;

FIG. 5 is a control block diagram of a refrigerator according to an embodiment of the disclosure;

FIGS. 6 and 7 are views illustrating guidance messages regarding input of an estimated consumption date, output from an output interface of a refrigerator according to various embodiments of the disclosure;

FIG. 8 is a view illustrating an estimated consumption date is received from a user according to an embodiment of the disclosure;

FIG. 9 is a view illustrating a guidance message regarding whether to proceed with consumption, output from an output interface of a refrigerator according to an embodiment of the disclosure;

FIG. 10 is a view illustrating temperature of a storage room where purchased articles are stored, depending on whether purchased articles are being consumed according to an embodiment of the disclosure;

FIGS. 11 and 12 are views illustrating guidance messages regarding whether to proceed with cooking, output from an output interface of a refrigerator according to various embodiments of the disclosure;

FIG. 13 is a control block diagram of a refrigerator further including a camera according to an embodiment of the disclosure;

FIG. 14 is a view illustrating a guidance message regarding whether to repurchase a purchased article, output from an output interface of a refrigerator according to an embodiment of the disclosure;

FIG. 15 is a view illustrating a message output from an output interface of a refrigerator based on a user input according to an embodiment of the disclosure;

FIG. 16 is a view illustrating a server communicating with a refrigerator according to an embodiment of the disclosure; and

FIGS. 17 and 18 are flowcharts illustrating a method for controlling a refrigerator according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In this document, each of the phrases “A or B,” “at least one of A and B,” “at least one of A or B,” “A, B or C,” “at least one of A, B and C,” and “at least one of A, B, or C” may include any of the items listed together in the corresponding phrase among those phrases, or any possible combination thereof.

Such terms as “1st” and “2nd,” or “first” and “second” may be used to simply distinguish a corresponding constituent element from another, and does not limit the constituent elements in other aspect (e.g., importance or order).

When a constituent element (e.g., a first constituent element) is referred to, with or without the term “operatively” or “communicatively,” as “coupled with,” “coupled to,” “connected with,” or “connected to” another constituent element (e.g., a second constituent element), it means that the constituent element may be coupled with the other constituent element directly (e.g., wiredly), wirelessly, or via a third constituent element.

It should be understood the terms “comprises,” “comprising,” “includes,” “including,” “containing,” “has,” “having” or other variations thereof are inclusive and therefore specify the presence of stated features, integers, steps, operations, elements, components, or combinations thereof disclosed in this document, but do not preclude the presence or addition of one or more other features, integers, steps, operations, elements, components, or combinations thereof.

When a constituent element is said to be “connected,” “coupled,” “supported,” or “in contact” with another constituent element, this includes not only cases where the constituent elements are directly connected, coupled, supported, or in contact with each other, but also cases where they are indirectly connected, coupled, supported, or in contact through a third constituent element.

When a constituent element is said to be located “on” another constituent element, this includes not only cases where the constituent element is in direct contact with the other constituent element, but also cases where another constituent element exists between the two constituent elements.

The term “and/or” includes a combination of a plurality of related listed constituent elements or any constituent element among the plurality of related constituent elements.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

Hereinafter, the principle of operation and embodiment of the disclosure will be described with reference to the accompanying drawings.

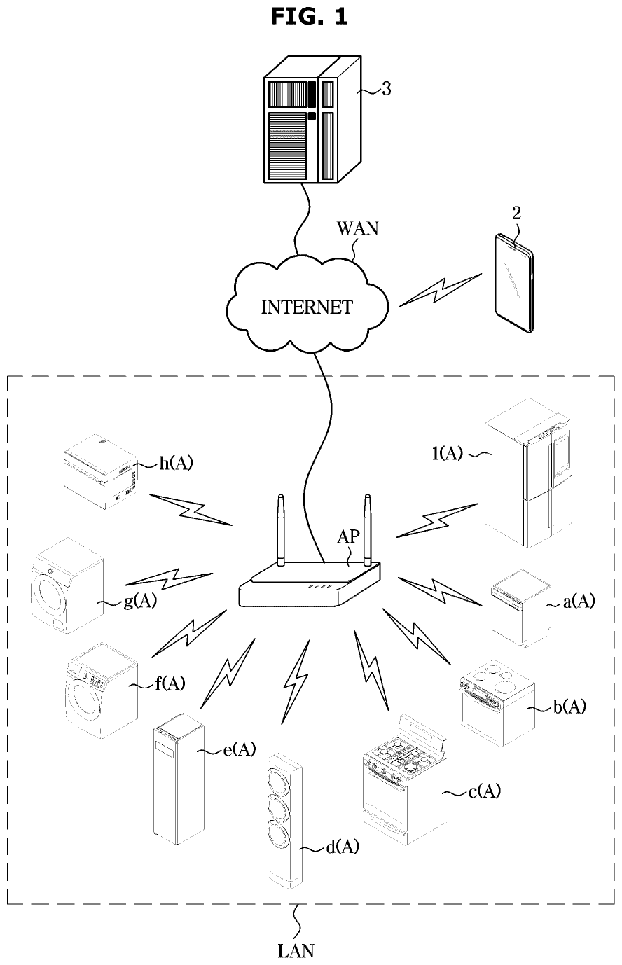

FIG. 1 is a view illustrating communication between a household appliance, a server, and a user device according to an embodiment of the disclosure.

Referring to FIG. 1, a household appliance A may include a communication module capable of communicating with another household appliance, a user device 2, or a server 3, a user interface for receiving a user input or outputting information to the user, at least one processor that controls the operation of the household appliance A, and at least one memory in which a program for controlling the operation of the household appliance A is stored.

The household appliance A may be at least one of various types of household appliances. For example, the household appliance A may include at least one of a refrigerator 1, a dishwasher a, an electric range b, an electric oven c, an air conditioner d, a garment care device e, a washing machine f, a dryer g, or a microwave oven h, as illustrated, but is not limited thereto. For example, it may also include various types of household appliances, such as a cleaning robot, a vacuum cleaner, a television, and others not illustrated in the drawings. In addition, the household appliances described above are merely examples, and devices other than the household appliances described above, which may be connected to another household appliance, user device 2, or server 3 to perform the operations described below, may also be included in the household appliance A according to an embodiment.

The server 3 may include a communication module capable of communicating with another server, household appliance A, or user device 2, at least one processor capable of processing data received from another server, household appliance A, or user device 2, and at least one memory capable of storing a program for processing data or processed data. Such a server 3 may be implemented as various computing devices, such as a workstation, cloud, data drive, or data station. The server 3 may be implemented as one or more servers physically or logically divided based on functions, detailed configurations of the functions, data, or the like, and may transmit and receive data through communication between each server and process the transmitted and received data.

The server 3 may perform functions, such as managing user accounts, registering the household appliance A in association with a user account, and managing or controlling the registered household appliance A. For example, the user may access the server 3 through the user device 2 and generate a user account. The user account may be identified by an identifier (ID) and password set by the user. The server 3 may register the household appliance A to the user account according to a predefined procedure. For example, the server 3 may register, manage, and control the household appliance A by linking the identify information of the household appliance A (e.g., serial number or medium access control (MAC) address) to the user account. The user device 2 may include a communication module capable of communicating with the household appliance A or server 3, a user interface for receiving a user input or outputting information to the user, at least one processor that controls the operation of the user device 2, and at least one memory in which a program for controlling the operation of the user device 2 is stored.

The user device 2 may be carried by the user or placed in the user's home, office, or other locations. The user device 2 may include a personal computer, terminal, portable telephone, smartphone, handheld device, wearable device, and the like, but is not limited thereto.

The memory of the user device 2 may store a program, i.e., an application, for controlling the household appliance A. The application may be sold pre-installed on the user device 2 or downloaded and installed from an external server.

By executing the application installed on the user device 2, the user may access the server 3, generate a user account, and communicate with the server 3 based on the logged-in user account to register the household appliance A.

For example, when the user operates the household appliance A in accordance with the procedure guided by the application installed on the user device 2 to allow the household appliance A to access the server 3, the identify information of the household appliance A (e.g., serial number or MAC address) may be registered to the corresponding user account in the server 3, thereby registering the household appliance A to the user account.

The user may control the household appliance A using the application installed on the user device 2. For example, when the user logs into the user account using the application installed on the user device 2, the household appliance A registered to the user account will appear, and by entering a control command for the household appliance A, the control command may be transmitted to the household appliance A through the server 3.

The network may include both wired and wireless networks. A wired network may include cable networks, telephone networks, or others, and a wireless network may include any network that transmits and receives signals through radio waves. The wired network and the wireless network may be interconnected.

The network may include a wide area network (WAN), such as the Internet, a local area network (LAN) formed around an access point (AP), and a short-range wireless network that does not pass through an access point (AP). The short-range wireless network may include Bluetooth™ (institute of electrical and electronics engineers (IEEE) 802.15.1), Zigbee (IEEE 802.15.4), Wi-Fi Direct, Near Field Communication (NFC), Z-Wave, and others, but is not limited thereto.

The access point (AP) may connect the household appliance A or user device 2 to the wide area network (WAN) connected to the server 3. The household appliance A or user device 2 may be connected to the server 3 through the wide area network (WAN).

The access point (AP) may communicate with the household appliance A or user device 2 using wireless communication, such as Wi-Fi™ (IEEE 802.11), Bluetooth™ (IEEE 802.15.1), or Zigbee (IEEE 802.15.4), and access the wide area network (WAN) using wired communication, but is not limited thereto.

Depending on various embodiments of the disclosure, the household appliance A may be directly connected to the user device 2 or server 3 without going through an access point (AP).

The household appliance A may be connected to the user device 2 or server 3 through a long-range wireless network or a short-range wireless network.

For example, the household appliance A may be connected to the user device 2 through a short-range wireless network (e.g., Wi-Fi Direct).

As another example, the household appliance A may be connected to the user device 2 or server 3 through the wide area network (WAN) using a long-range wireless network (e.g., cellular communication module).

As another example, the household appliance A may access the wide area network (WAN) using wired communication and be connected to the user device 2 or server 3 through the wide area network (WAN).

When it is possible for the household appliance A to access the wide area network (WAN) through wired communication, it may operate as an access point. Accordingly, the household appliance A may connect another household appliance to the wide area network (WAN) connected to the server 3. Additionally, another household appliance may connect the household appliance A to the wide area network (WAN) connected to the server 3.

The household appliance A may transmit information on its operation or state to another household appliance, user device 2, or server 3 through the network. For example, the household appliance A may transmit information on its operation or state to another household appliance, user device 2, or server 3 when a request is received from the server 3, when a specific event occurs in the household appliance A, or periodically or in real-time. When the server 3 receives information on the operation or state from the household appliance A, it updates the stored information on the operation or state of the household appliance A, and may transmit the updated information on the operation and state of the household appliance A to the user device 2 through the network. Here, the update of the information includes various operations in which the existing information is changed, such as adding new information to the existing information or replacing the existing information with new information.

The household appliance A may acquire various information from another household appliance, user device 2, or server 3, and provide the acquired information to the user. For example, the household appliance A may acquire information related to the functions of the household appliance A (e.g., cooking methods, washing methods, or the like), various environmental information (e.g., weather, temperature, humidity, or the like) from the server 3, and output the acquired information through the user interface.

The household appliance A may operate according to control commands received from another household appliance, user device 2, or server 3. For example, when the household appliance A has acquired prior approval from the user, it may operate according to the control commands received from the server 3, allowing for operation in accordance with the control commands from the server 3 even without a user input. Here, the control commands received from the server 3 may include control commands entered by the user through the user device 2 or control commands based on preset conditions, but are not limited thereto.

The user device 2 may transmit information on the user to the household appliance A or server 3 through the communication module. For example, the user device 2 may transmit information on the user's location, health status, preferences, schedule, and others to the server 3. The user device 2 may transmit information on the user to the server 3 with the user's prior approval.

The household appliance A, user device 2, or server 3 may determine control commands using technologies, such as artificial intelligence. For example, the server 3 may receive information on the operation or state of the household appliance A or information on the user from the user device 2, process it using technologies, such as artificial intelligence, and based on the processing results, transmit the processing results or control commands to the household appliance A or user device 2.

Hereinafter, the refrigerator 1 among the household appliances A, the server 3 managing the refrigerator, and the method for controlling the refrigerator will be described.

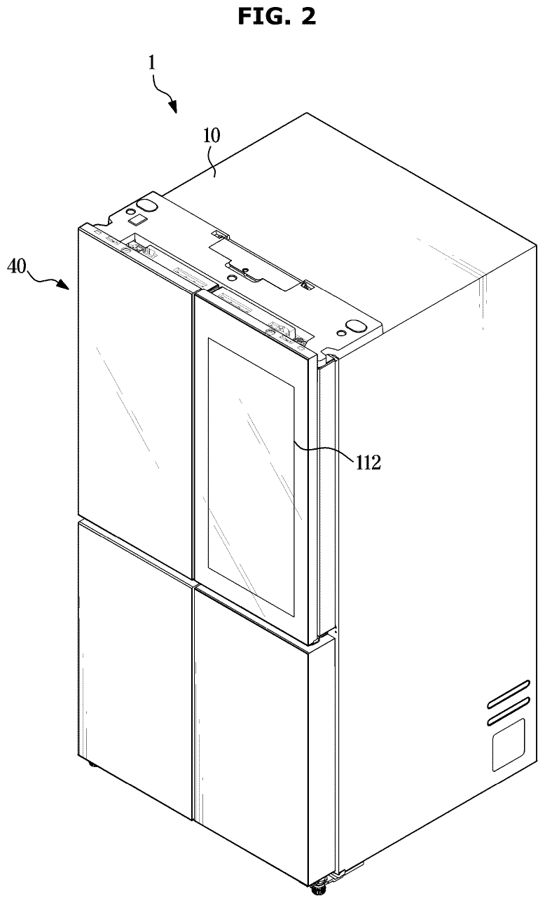

FIG. 2 is an exterior view of a refrigerator with a door closed according to an embodiment of the disclosure.

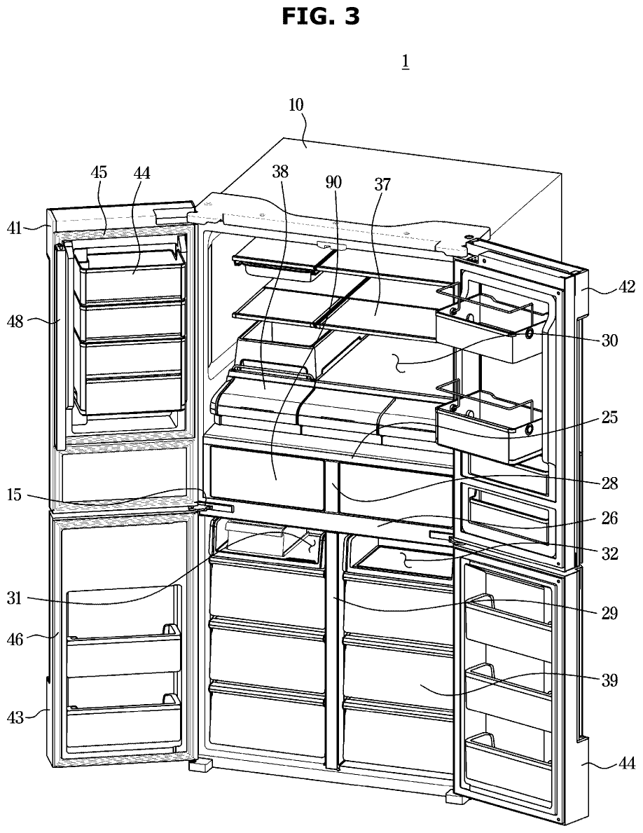

FIG. 3 is an exterior view of a refrigerator with a door open according to an embodiment of the disclosure.

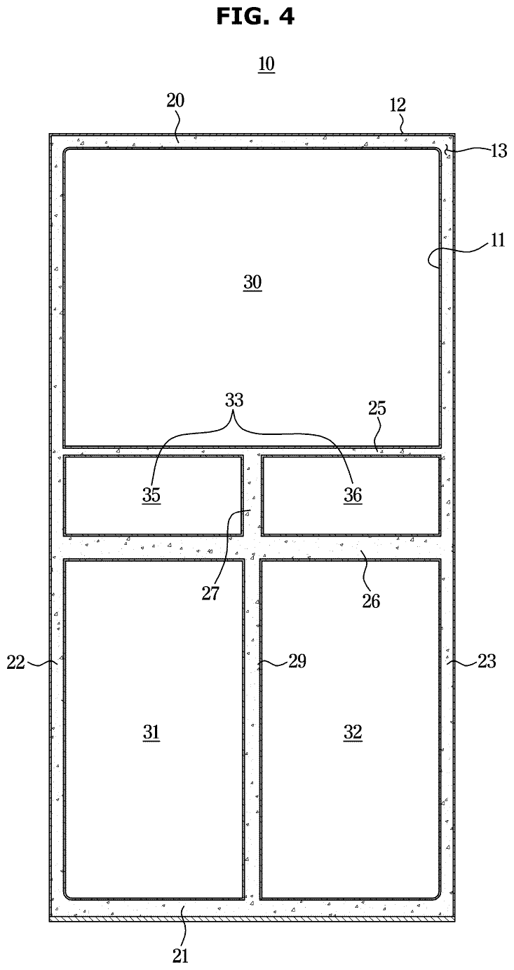

FIG. 4 is a schematic cross-sectional view illustrating a spatial partition of a refrigerator according to an embodiment of the disclosure.

Referring to FIGS. 2, 3, and 4 together, the refrigerator 1 may include a main body 10, a plurality of storage rooms 30, 31, 32, and 33 formed inside the main body 10 to store food, a door 40 that opens and closes the plurality of storage rooms 30, 31, 32, and 33, and a user interface 110 that includes an input interface 111 and an output interface 112.

In the example, it is described by taking the case where the door 40 includes four doors 41, 42, 43, and 44.

The plurality of storage rooms 30, 31, 32, and 33 may include an upper storage room 30, lower storage rooms 31 and 32, and an intermediate storage room 33 formed between the upper storage room 30 and the lower storage rooms 31 and 32.

The upper storage room 30 may be a refrigerating compartment (i.e., the storage room 30) for storing food in a refrigerated state. The refrigerating compartment (i.e., the storage room 30) may be maintained at approximately 0 to 5° C. to store food in a refrigerated state.

The lower storage rooms 31 and 32 may include a first freezing compartment (i.e., the storage room 31) for storing food in a frozen state and a first variable temperature compartment (i.e., the storage room 32) with adjustable temperature. The first freezing compartment (i.e., the storage room 31) may be maintained at approximately 0 to −30° C. to store food in a frozen state.

The first variable temperature compartment (i.e., the storage room 32) may have its temperature adjusted between refrigeration and freezing temperatures. As an example, the first variable temperature compartment (i.e., the storage room 32) may have its temperature adjusted within one of the four temperature zones including a freezing temperature zone of −23° C. to −17° C., a slush temperature zone of −5° C., a special selection temperature zone of-1° C., and a refrigeration temperature zone of 2° C.

When a selection for a temperature zone is input by the user, the refrigerator 1 may adjust the temperature of the first variable temperature compartment (i.e., the storage room 32) to the selected temperature zone.

The intermediate storage room 33 may include a second freezing compartment 35 and a second variable temperature compartment 36 provided side by side in the left and right directions.

The second freezing compartment 35 may be maintained at approximately 0 to −30° C., similar to the first freezing compartment (i.e., the storage room 31), to store food in a frozen state.

The second freezing compartment 35 may be provided relatively smaller than the first freezing compartment (i.e., the storage room 31) and function as an auxiliary freezing compartment. The first freezing compartment (i.e., the storage room 31) may be opened and closed by a first lower door 43, and the second freezing compartment 35 may be opened and closed by a first upper door 41. As an example, relatively large food items with low access frequency may be stored in the first freezing compartment (i.e., the storage room 31), while relatively small food items with high access frequency may be stored in the second freezing compartment 35, thus improving storage management efficiency and minimizing unnecessary cold air leakage.

The second variable temperature compartment 36, like the first variable temperature compartment (i.e., the storage room 32), may have its temperature adjusted between refrigeration and freezing temperatures.

However, it is not necessary for an embodiment of the disclosure of the refrigerator 1 to include the second variable temperature compartment 36. Instead of the second variable temperature compartment 36, a freezing compartment may be provided, making it possible for the entire intermediate storage room 33 to be implemented as a freezing compartment.

The main body 10 has a roughly box-shaped structure and is provided with an open front surface. The main body 10 includes an inner frame 11, an outer frame 12 that is coupled to the outside of the inner frame 11, and an insulation 13 provided between the inner frame 11 and the outer frame 12.

The inner frame 11 may be formed by injection molding using a resin material. The inner frame 11 may form the refrigerating compartment (i.e., the storage room 30), the first freezing compartment (i.e., the storage room 31), the first variable temperature compartment (i.e., the storage room 32), the second freezing compartment 35, and the second variable temperature compartment 36, as described above, therein. For example, the inner frame 11 may define the range of each storage room.

The outer frame 12 may be formed of a metal material. The insulation provided between the inner frame 11 and the outer frame 12 may use urethane foam insulation, and, if necessary, a vacuum insulation panel may be used in conjunction.

The main body 10 may include a top wall 20, a bottom wall 21, a left wall 22, a right wall 23, a rear wall 24, a first partition wall 25, a second partition wall 26, a first intermediate wall 27, and a second intermediate wall 29.

The first partition wall 25 partitions the internal space of the main body 10 into upper and lower sections. For example, the first partition wall 25 partitions the refrigerating compartment (i.e., the storage room 30) from the intermediate storage room 33. The first partition wall 25 extends approximately horizontally from the left wall 22 to the right wall 23 and includes the inner frame 11 and insulation 13.

The second partition wall 26 partitions the internal space of the main body 10 into upper and lower sections. For example, the second partition wall 26 partitions the intermediate storage room 33. The second partition wall 26 extends approximately horizontally from the left wall 22 to the right wall 23 and includes the inner frame 11 and insulation 13.

The first intermediate wall 27 partitions the intermediate storage room 33 into left and right sections. For example, the first intermediate wall 27 partitions the second freezing compartment 35 and the second variable temperature compartment 36. The first intermediate wall 27 extends approximately vertically from the first partition wall 25 to the second partition wall 26 and includes the inner frame 11 and insulation 13.

The second intermediate wall 29 partitions the lower storage rooms 31 and 32 into left and right sections. For example, the second intermediate wall 29 partitions the first freezing compartment (i.e., the storage room 31) and the first variable temperature compartment (i.e., the storage room 32). The second intermediate wall 29 extends approximately vertically from the second partition wall 26 to the bottom wall 21 and includes the inner frame 11 and insulation 13.

Each storage room may be provided with a shelf 37 for placing food, a sealed container 38 for storing food in a sealed state, and a drawer 39 that may be inserted and withdrawn by sliding in the front-to-back direction.

The second freezing compartment 35 may be provided with a mini freezer box 90 that has a storage space for storing food. The mini freezer box 90 may be provided in the second freezing compartment 35, which has a relatively narrow space, to facilitate the storage and access of food.

The door 40 that opens and closes the plurality of storage rooms 30, 31, 32, and 33 may include four doors of the first upper door 41, second upper door 42, first lower door 43, and second lower door 44. Each of the doors 41, 42, 43, and 44 may be rotatably coupled to the main body 10.

The first upper door 41 and the second upper door 42 may be rotatably coupled to the main body 10 by an upper hinge and a middle hinge 15, respectively. The middle hinge 15 may be coupled to the second partition wall 26 to support the first upper door 41 and the second upper door 42. The first upper door 41 and the second upper door 42 may rotate in opposite directions to open and close.

The first upper door 41 and the second upper door 42 may open and close the refrigerating compartment (i.e., the storage room 30) and the intermediate storage room 33 together. Specifically, the first upper door 41 may open and close a portion of the refrigerating compartment (i.e., the storage room 30) and the second freezing compartment 35, while the second upper door 42 may open and close the remaining portion of the refrigerating compartment (i.e., the storage room 30) and the second variable temperature compartment 36.

The portion of the refrigerating compartment (i.e., the storage room 30) that is opened and closed by the first upper door 41 may be the area facing the first upper door 41 when the first upper door 41 is closed, and the remaining portion of the first freezing compartment (i.e., the storage room 31) that is opened and closed by the second upper door 42 may be the area facing the second upper door 42 when the second upper door 42 is closed.

Therefore, when the first upper door 41 is opened, both the refrigerating compartment (i.e., the storage room 30) and the second freezing compartment 35 may be opened simultaneously, and when the second upper door 42 is opened, both the refrigerating compartment (i.e., the storage room 30) and the second variable temperature compartment 36 may be opened simultaneously.

The first upper door 41 may be provided with a filler 48 to prevent cold air from leaking between the first upper door 41 and the second upper door 42 in a state where the first upper door 41 and second upper door 42 is closed.

On the rear surface of the upper doors 41 and 42, an upper sealing member 45 may be provided to prevent cold air from leaking between the upper doors 41 and 42 and the main body 10 in a state where the upper doors 41 and 42 are closed. On the rear surface of the lower doors 43 and 44, a lower sealing member 46 may be provided to prevent cold air from leaking between the lower doors 43 and 44 and the main body 10 in a state where the lower doors 43 and 44 are closed. The sealing members 45 and 46 may be formed of a rubber material.

The first lower door 43 and the second lower door 44 may each be rotatably coupled to the main body 10 by the middle hinge 15 and lower hinge. The first lower door 43 and the second lower door 44 may rotate in opposite directions to open and close.

The first lower door 43 may open and close the first freezing compartment (i.e., the storage room 31). The second lower door 44 may open and close the first variable temperature compartment (i.e., the storage room 32).

Meanwhile, the storage room for storing food may be provided not only in the main body 10 but also in the door 40. For example, various types of door shelves that may hold food may be mounted on the rear side of the door 40. As an example, the door shelf may be used to separately store food items, such as liquids like beverages, alcohol, bottled water, and milk, as well as food items with specific shapes, such as eggs, which may be at risk of breaking.

The structure and shape of the refrigerator 1 described above are merely examples applicable to the refrigerator 1 according to an embodiment of the disclosure, and the refrigerator 1 according to an embodiment of the disclosure may have other shapes and structures in addition to the aforementioned structure and shape. However, for the sake of specific explanation, the embodiments described below are explained based on the refrigerator 1 having the structure and shape illustrated in FIGS. 1 to 3.

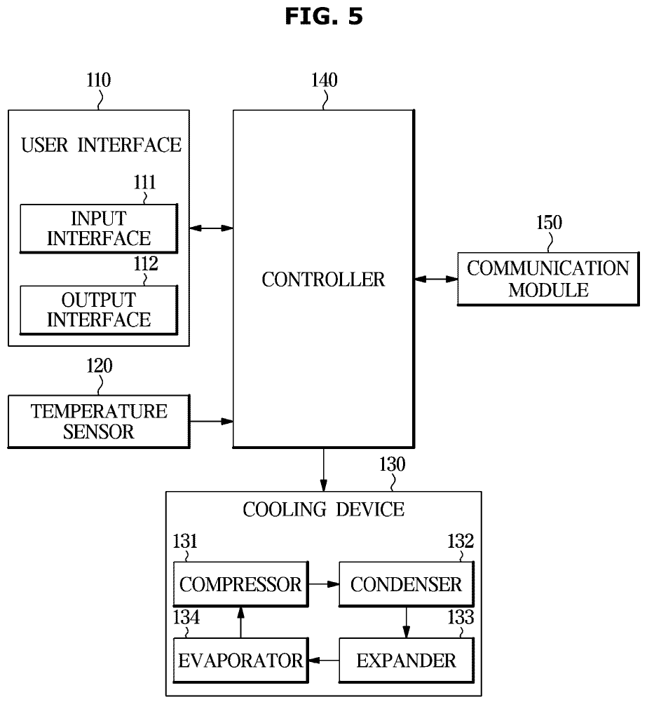

FIG. 5 is a control block diagram of a refrigerator according to an embodiment of the disclosure.

Referring to FIG. 5, the refrigerator 1 according to an embodiment includes a user interface 110, a temperature sensor 120, a cooling device 130, a communication module 150, and a controller 140 that controls the same. All constituent elements are electrically connected and may communicate with each other.

The user interface 110 is provided on the door 40 and may receive an input from the user or display various information regarding the refrigerator 1.

The user interface 110 may include an input interface 111 for receiving an input from the user and an output interface 112 for outputting various information regarding the refrigerator 1.

The input interface 111 may include keys, a touchscreen, a microphone, and others. In addition, the input interface 111 may receive a user input and transmit it to the controller 140.

The output interface 112 may include a display, a speaker, and others. The output interface 112 may output various notifications, messages, and information generated by the controller 140.

The temperature sensor 120 refers to a sensor that may measure the temperature of the storage room. For example, the temperature sensor 120 may be a thermistor, which changes its electrical resistance value according to the temperature.

The temperature sensor 120 may measure the temperature of each of the plurality of storage rooms 30, 31, 32, and 33. To the end, a plurality of temperature sensors 120 may be provided.

The temperature sensor 120 may be provided for each of the plurality of storage rooms 30, 31, 32, and 33, and the temperature sensor 120 may measure the temperature of each of the plurality of storage rooms 30, 31, 32, and 33.

The temperature sensor 120 may provide an electrical signal (e.g., a voltage signal or current signal) corresponding to the measured temperatures of the plurality of storage rooms 30, 31, 32, and 33 to the controller 140. The controller 140 may identify the temperature of each of the plurality of storage rooms 30, 31, 32, and 33 based on the electrical signals received from the temperature sensor 120.

The cooling device 130 may maintain the temperature of the plurality of storage rooms 30, 31, 32, and 33 within a set range by supplying cold air to the plurality of storage rooms 30, 31, 32, and 33 using the evaporation of the refrigerant.

The cooling device 130 may include a compressor 131 that compresses the gaseous refrigerant, a condenser 132 that converts the compressed gaseous refrigerant into a liquid refrigerant, an expander 133 that depressurizes the liquid refrigerant, and an evaporator 134 that converts the depressurized liquid refrigerant into a gaseous state.

The compressor 131 compresses the low-temperature, low-pressure refrigerant in a gaseous state that is suctioned in and discharges it as a high-temperature, high-pressure gaseous state. To this end, the compressor 131 forcibly suction in the refrigerant, compresses the suctioned refrigerant, and changes it into a high-temperature, high-pressure gas. The suction of the refrigerant may be performed using the rotational force of a built-in motor.

The refrigerant may be circulated within the cooling cycle of the refrigerator 1 by the force with which the compressor 131 suctions in the refrigerant. Therefore, the amount or speed of the refrigerant circulation may be determined according to the degree to which the compressor 131 is driven, and further, the cooling efficiency of the refrigerator 1 may be determined.

The high-temperature, high-pressure refrigerant in a gaseous state compressed by the compressor 131 is transferred to the condenser 132.

The condenser 132 is connected to the high-pressure discharge pipe of the compressor 131 and condenses the high-temperature, high-pressure refrigerant in a gaseous state, which is compressed by the compressor 131, into a liquid state by exchanging heat with the surrounding air. In the condenser 132, the refrigerant liquefies while releasing heat to the outside, thereby lowering the temperature of the refrigerant.

The expander 133 expands the refrigerant in a liquid state at a room-temperature and high-pressure, which is condensed and comes from the condenser 132, into a two-phase refrigerant that is a mixture of liquid and gas components at low temperature and low pressure, thus reducing the pressure, and consists of an expansion valve.

Additionally, the expander 133 may be replaced with a capillary tube instead of the expansion valve. The capillary tube may be implemented by a thin tube, and the refrigerant passing through the capillary tube is depressurized and then delivered to the evaporator 134.

The evaporator 134 evaporates the low-temperature, low-pressure refrigerant in a liquid state expanded from the expander 133 into a gaseous state, thereby supplying cold air.

In this way, the cooling device 130 may supply cold air to the plurality of storage rooms 30, 31, 32, and 33 using the phenomenon in which the depressurized liquid refrigerant undergoes a state change into a gaseous state while absorbing thermal energy from the surrounding air.

Meanwhile, some of the plurality of storage rooms 30, 31, 32, and 33 may have their temperature controlled independently. To this end, a plurality of cooling devices 130 may be provided. It is possible for the plurality of cooling devices 130 to be configured independently, or for some constituent elements to be shared.

For example, three cooling devices 130 may be provided. One of the three cooling devices 130 may supply cold air to the refrigerating compartment (i.e., the storage room 30), another may supply cold air to the first freezing compartment (i.e., the storage room 31) and the second freezing compartment 35, and the remaining one may supply cold air to the first variable temperature compartment (i.e., the storage room 32) and the second variable temperature compartment 36.

The controller 140 may transmit control signals to the cooling device 130 that supplies cold air to the refrigerating compartment (i.e., the storage room 30) in order to control the temperature of the refrigerating compartment (i.e., the storage room 30), transmit control signals to the cooling device 130 that supplies cold air to the first freezing compartment (i.e., the storage room 31) and the second freezing compartment 35 in order to control the temperatures of the first freezing compartment (i.e., the storage room 31) and the second freezing compartment 35, and transmit control signals to the cooling device 130 that supplies cold air to the first variable temperature compartment (i.e., the storage room 32) and the second variable temperature compartment 36 in order to control the temperatures of the first variable temperature compartment (i.e., the storage room 32) and the second variable temperature compartment 36.

For example, the controller 140 may determine the storage temperature of the purchased article based on the product information of the purchased article and the estimated consumption date input by the user, and control the temperature of the storage room where the purchased article is stored to the determined storage temperature.

The controller 140 may include memory that stores or memorizes programs and/or data for controlling the aforementioned operation and the refrigerator 1 described below, and a processor that outputs control signals to control the cooling device 130, or the like, according to the programs and/or data memorized in the memory.

The memory stores or records various information, data, instructions, programs, and others necessary for the operation of the refrigerator 1. The memory may memorize temporary data generated during the process of generating control signals to control the configurations included in the refrigerator 1. The memory may include at least one of volatile memory or non-volatile memory, or a combination thereof.

The processor controls the overall operation of the refrigerator 1. The processor may execute the program stored in the memory to control the constituent elements of the refrigerator 1. The processor may include a separate NPU for performing the operation of an artificial intelligence model. In addition, the processor may include a central processing unit, a graphics processing unit (GPU), and others. The processor may generate control signals to control the operation of the cold air supply system. For example, the processor may receive temperature information of the storage room from the temperature sensor 120 and generate a cooling control signal to control the operation of the cooling device 130 based on the temperature information of the storage room.

Additionally, the processor may process a user input from the user interface 110 and control the operation of the user interface 110 based on the programs and/or data memorized/stored in the memory. The user interface 110 may be provided using the input interface 111 and the output interface 112. The processor may receive a user input from the user interface 110. In addition, the processor may, in response to a user input, transmit display control signals and video data for displaying images on the user interface 110 to the user interface 110.

The processor and memory may be provided integrally or separately. The processor may include one or more processors. For example, the processor may include a main processor and at least one sub-processor. The memory may include one or more memories.

The communication module 150 may communicate with external devices, such as the server 3, mobile devices, and other household appliances through a nearby access point (AP). The access point (AP) may connect the local area network (LAN) to which the refrigerator 1 or user device 2 is connected to the wide area network (WAN) to which the server 3 is connected. The refrigerator 1 or user device 2 may be connected to the server 3 through the wide area network (WAN).

The communication module 150, under the control command of the controller 140, may receive various information related to the control of the refrigerator 1 from external devices, such as the server 3, user device 2, or other household appliances, and may transmit various information related to the control of the refrigerator 1 to external devices, such as the server 3, user device 2, or other household appliances.

The communication module 150 may receive the product information of the purchased article purchased by the user (hereinafter referred to as the purchased article) from the server 3 or user device 2. The product information of the purchased article may include the product name, expiration date, storage method, an image of the purchased article, and others.

Specifically, the communication module 150 may receive the purchase history and the product information of the purchased article stored in the application of the server 3 or user device 2 from the server 3 or user device 2.

The controller 140 may control the temperature of the storage room where the purchased article is stored based on the received product information of the article and the estimated consumption date of the purchased article input by the user. The estimated consumption date refers to a date on which the user will no longer store the purchased article in the refrigerator 1, as the user will have cooked the purchased article. The estimated consumption date may be input through the user device 2, the input interface 111, or the like.

The controller 140 may control the temperature of the storage room where the purchased article is stored by comparing the estimated consumption date and the reference date.

The controller 140 may determine the reference date based on the received product information of the article. For example, the controller 140 may determine the reference date to be the same date as the expiration date of the article, determine the reference date to be the date that is 7 days from the date the article was stored, or determine the reference date based on the storage method and expiration date of the received product.

The storage room where the purchased article is stored is one of the plurality of storage rooms 30, 31, 32, and 33, and the controller 140 may determine the storage room where the purchased article is stored based on a user input. However, the determination of the storage room where the purchased article is stored is not limited to the above-described embodiment and may include all means and methods for determining the storage room where the purchased article is stored. For example, a camera may be provided within the storage room to determine the storage room where the purchased article is stored.

The controller 140 may control the temperature of the storage room where the purchased article is stored to a first temperature (e.g., −5° C.) when the estimated consumption date is earlier than the reference date. When the estimated consumption date is the same as or later than the reference date, the controller 140 may control the temperature of the storage room where the purchased article is stored to a second temperature (e.g., −18° C.) lower than the first temperature. The controller 140 may also control the output interface 112 to output a guidance message for setting the temperature of the storage room where the purchased article is stored.

For example, when the estimated consumption date is Aug. 4, 2022, and the reference date is Aug. 5, 2022, the controller 140 may control the temperature of the storage room where the purchased article is stored to the first temperature. When the estimated consumption date is Aug. 5, 2022, and the reference date is also Aug. 5, 2022, the controller 140 may control the temperature of the storage room where the purchased article is stored to the second temperature.

Additionally, the controller 140 may control the temperature of the storage room where the purchased article is stored based on a signal received from the server 3 for controlling the temperature of the storage room where the purchased article is stored.

Hereinafter, various embodiments in which the controller 140 controls each constituent element of the refrigerator 1 based on the received product information of the article and user input will be described below.

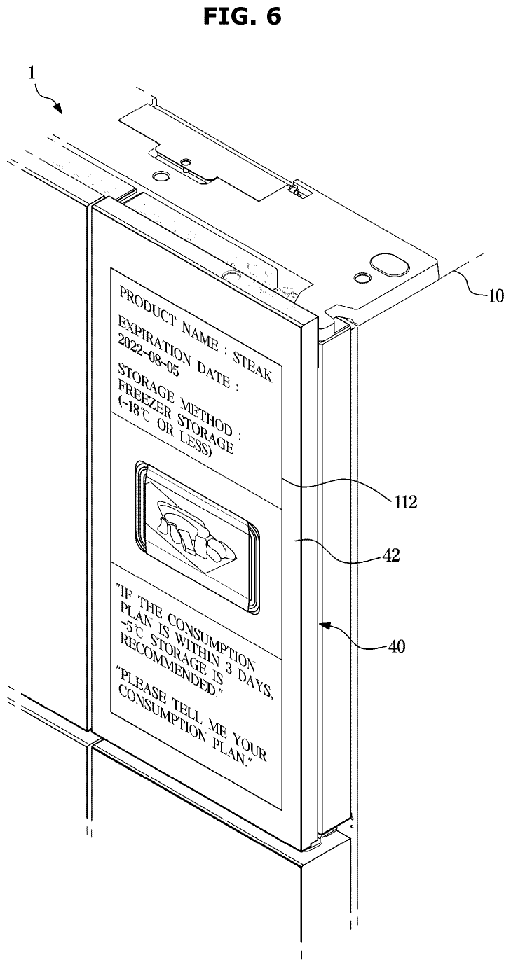

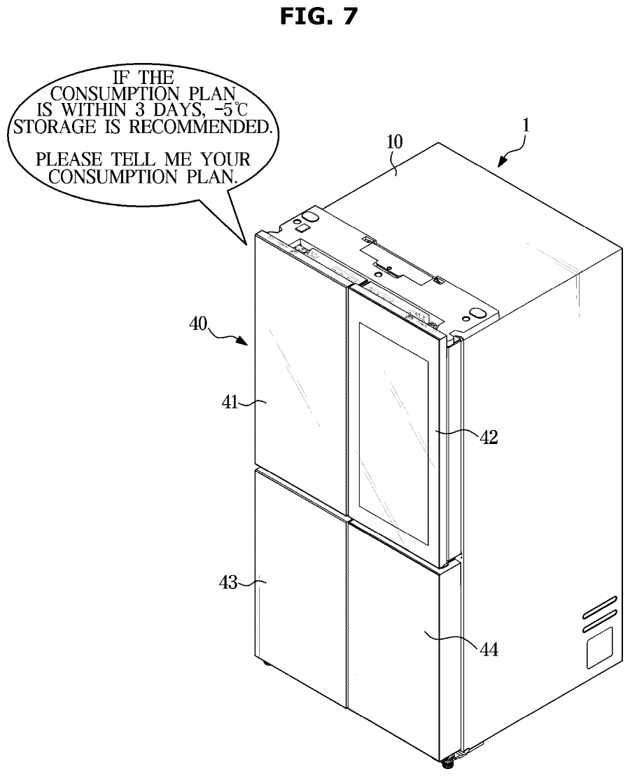

FIGS. 6 and 7 are views illustrating guidance messages regarding an input of an estimated consumption date, output from an output interface of a refrigerator according to various embodiments of the disclosure.

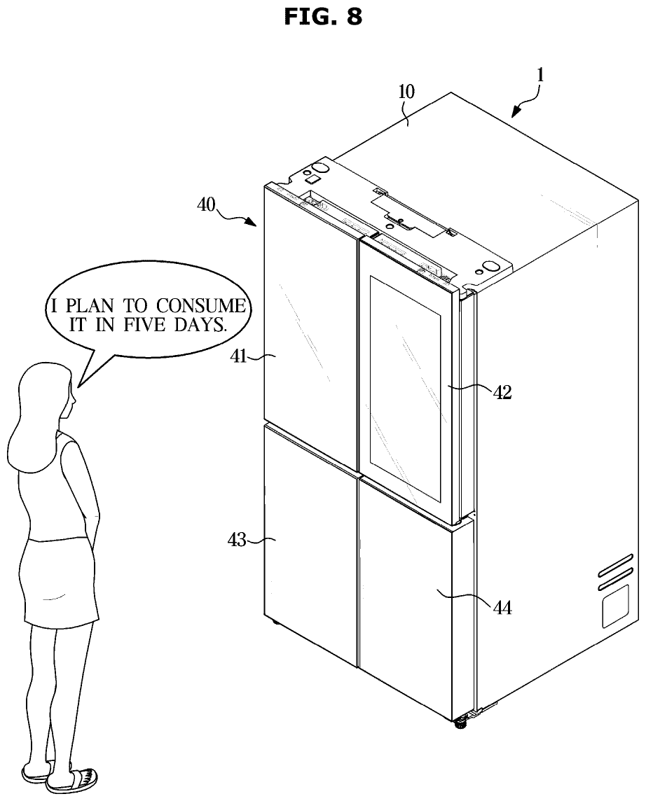

FIG. 8 is a view illustrating receiving an estimated consumption date from a user according to an embodiment of the disclosure.

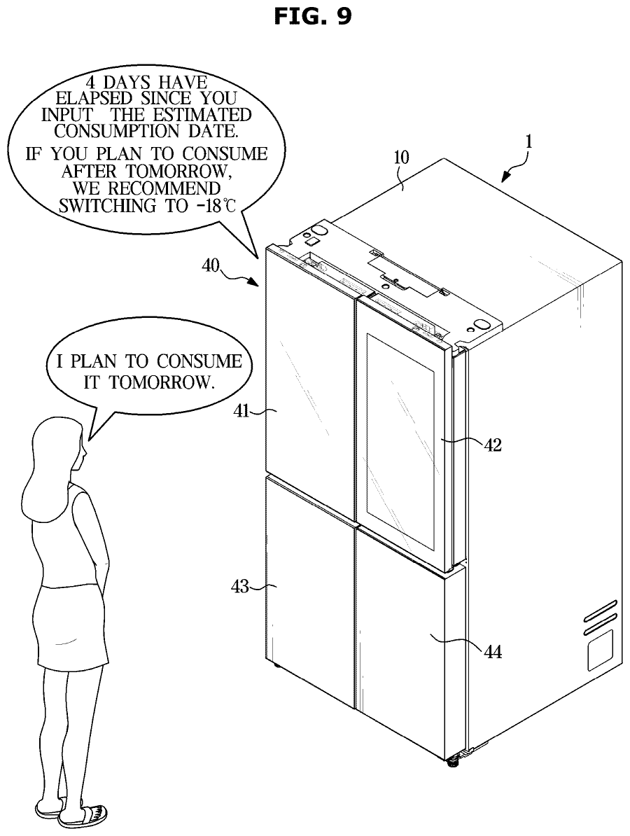

FIG. 9 is a view illustrating a guidance message regarding whether to proceed with consumption, output from an output interface of a refrigerator according to an embodiment of the disclosure.

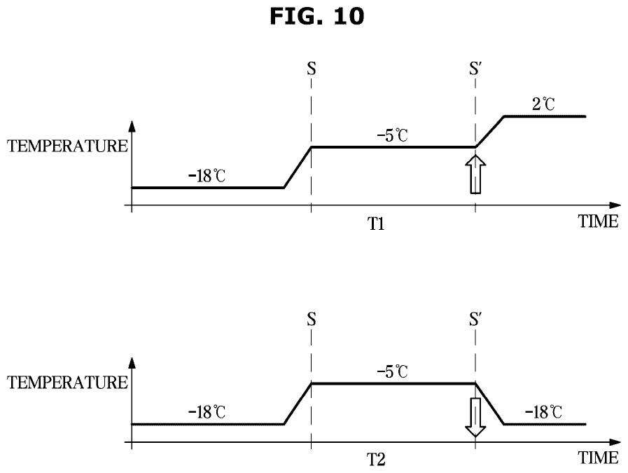

FIG. 10 is a view illustrating temperature of a storage room where purchased articles are stored, depending on whether purchased articles are being consumed according to an embodiment of the disclosure.

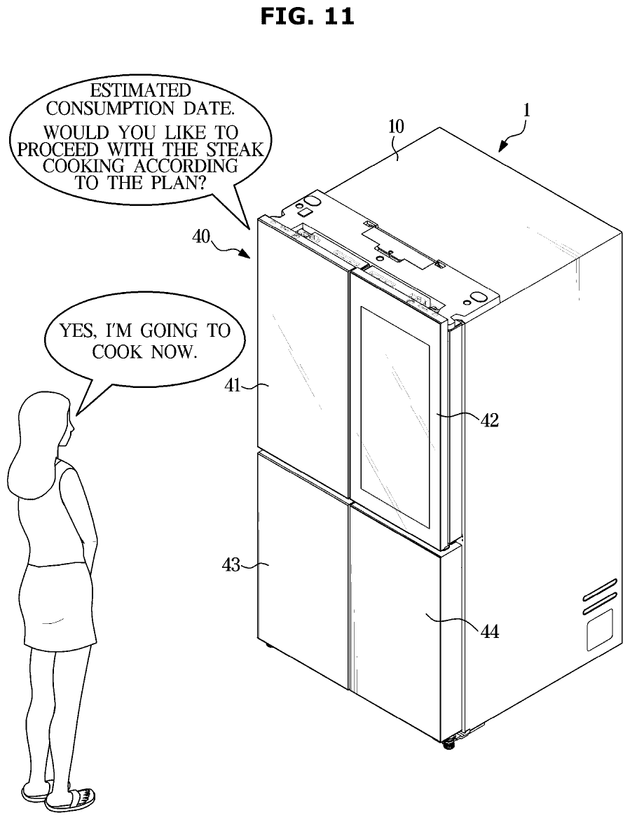

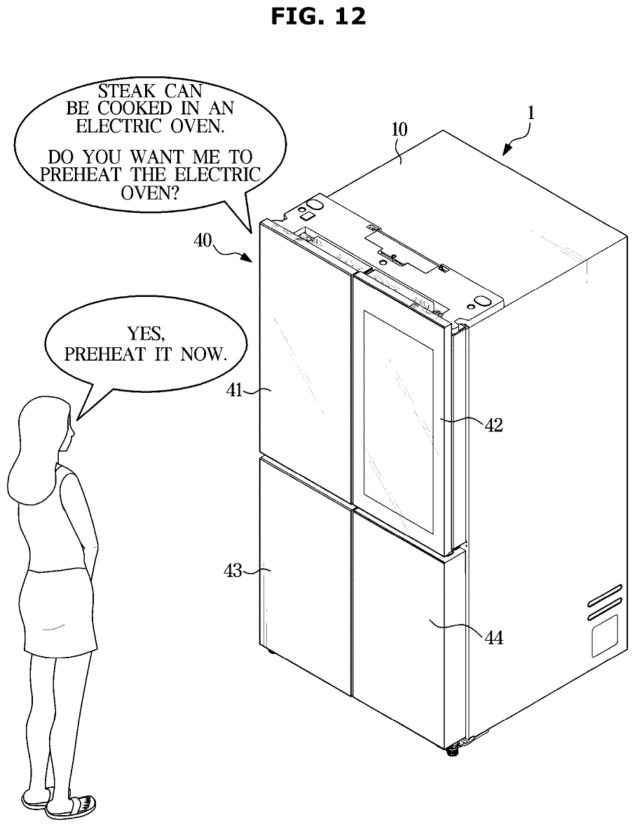

FIGS. 11 and 12 are views illustrating guidance messages regarding whether to proceed with cooking output from an output interface of a refrigerator according to various embodiments of the disclosure.

When receiving the product information of the user's purchased article through the communication module 150, the controller 140 may control the output interface 112 to output the product information of the purchased article.

Additionally, when receiving the product information of the user's purchased article, the controller 140 may control the output interface 112 to output a guidance message to guide the user to input the estimated consumption date.

Referring to FIG. 6, the display among the output interfaces 112 may output the product information of the purchased article. Specifically, the display may output the product name, expiration date, storage method, and image of the purchased article. However, the information output on the display is not limited to the examples described above and may include various types of information related to the purchased article. For example, it may include cooking methods.

In addition, referring to FIG. 6, the display may output a guidance message to guide the input of the estimated consumption date. However, the guidance message to guide the input of the estimated consumption date output from the output interface 112 is not limited to being output through the display. Referring to FIG. 7, the guidance message may also be output through the speaker to guide the input of the estimated consumption date, or may be output by communicating with the user device 2.

The user may input the estimated consumption date into the refrigerator 1. Specifically, referring to FIG. 8, the user may input the estimated consumption date through the microphone among the input interfaces 111.

The estimated consumption date may be input through the input interface 111, such as a touchscreen, in addition to the microphone, or may be received from the user device 2 through the communication module 150.

As described above, the controller 140 may control the temperature of the storage room where the purchased article is stored based on the received product information of the article and the estimated consumption date of the purchased article input by the user.

The controller 140 may determine whether a preset period has elapsed from the date the estimated consumption date was input.

The preset period may be determined as a specific period (e.g., 4 days) or may be determined based on the estimated consumption date. For example, when the estimated consumption date is 7 days away from the date the estimated consumption date was input, the preset period may be determined as 6 days.

The controller 140 may control the output interface 112 to output a guidance message to guide the user to input whether to proceed with consumption when the preset period has elapsed from the date the estimated consumption date was input.

Referring to FIG. 9, a guidance message to guide the user to input whether to proceed with consumption may be output through the speaker. As described above, the guidance message may also be output through the display, user device 2, or other means. The user may input whether to proceed with consumption through the microphone, user device 2, or other means.

The controller 140 may control the temperature of the storage room where the purchased article is stored based on a command related to whether to proceed with consumption, when the command related to whether to proceed with consumption is input from the user.

This is described with reference to FIG. 10, which illustrates controlling the temperature of the storage room where the purchased article is stored.

The graphs shown in FIG. 10 represent the graph T1 showing the temperature change when a consumption start command is input from the user, and the graph T2 showing the temperature change when a consumption cancel command is input from the user.

The X-axis of the graph represents time, while the Y-axis represents temperature. S represents the reference date as described above, and S′ represents the time when a command related to whether to proceed with consumption is input from the user.

Referring to FIG. 10, when the estimated consumption date is later than or the same as the reference date (the area before S), the temperature of the storage room where the purchased article is stored may be set to the second temperature (e.g., −18° C.).

When the estimated consumption date is earlier than the reference date (the area between S and S′), the temperature of the storage room where the purchased article is stored may be controlled to the first temperature (e.g., −5° C.).

When a command related to whether to proceed with consumption is input from the user (the area after S′), the temperature of the storage room where the purchased article is stored may be controlled based on the user's command.

When a consumption start command is input from the user, the temperature of the storage room where the purchased article is stored may be controlled to the first temperature. With reference to T1 in FIG. 10, when a consumption start command is input from the user (the area after S′), the temperature of the storage room where the purchased article is stored may be increased to control the temperature of the storage room where the purchased article is stored on the estimated consumption date as the third temperature (e.g., 2) higher than the first temperature, thereby thawing the purchased article.

With reference to T2 in FIG. 10, when a consumption cancel command is input from the user (the area after S′), the temperature of the storage room where the purchased article is stored may be lowered, and the temperature of the storage room where the purchased article is stored may be controlled to the second temperature.

The controller 140 may compare the control temperature based on the existing purchased article and the control temperature based on a new purchased article when the new purchased article is stored in the storage room where the existing purchased article is stored while controlling the temperature of the storage room where the purchased article is stored.

When the control temperature based on the existing purchased article and the control temperature based on the new purchased article are different, the controller 140 may control the output interface to output a message guiding the user to store the new purchased article in a different storage room.

The controller 140 may control the output interface 112 to output a guidance message to the user regarding whether to proceed with cooking when the estimated consumption date arrives.

Referring to FIG. 11, a guidance message to guide the user to input whether to proceed with cooking may be output through the speaker. As described above, the guidance message may also be output through the display, user device 2, or other means. The user may input whether to proceed with cooking through the microphone, user device 2, or other means.

The controller 140 may control the temperature of the storage room where the purchased article is stored or the communication module 150 based on a command related to whether to proceed with cooking, when the command related to whether to proceed with cooking is input from the user.

Specifically, when a cooking cancel command is input, the controller 140 may control the temperature of the storage room where the purchased article is stored to the second temperature.

In addition, the controller 140 may determine the home appliance (e.g., an electric oven) for cooking based on the cooking method of the purchased article when a cooking start command is input from the user, and may transmit a control command to the determined home appliance. For example, when a cooking start command is input from the user, the controller 140 may transmit a preheating command to the electric oven based on the cooking method of the purchased article.

Referring to FIG. 12, the controller 140 may output a guidance message to obtain consent for transmitting a control command to the household appliance for cooking. When a consent command is input from the user, the controller 140 may transmit a control command to the household appliance for cooking. Alternatively, unlike FIG. 12, when a cooking start command is input from the user, the controller 140 may transmit a control command to the household appliance for cooking.

The controller 140, upon receiving a control command execution completion signal from the household appliance for cooking through the communication module 150, may control the output interface 112 to output a guidance message of the execution completion of the control command. For example, when receiving a preheating completion signal from the electric oven, the controller 140 may output a preheating completion message through the output interface 112. Based on the control command execution completion guidance, the user may proceed to cook the purchased article.

Additionally, when receiving a cooking completion signal from the household appliance for cooking, the controller 140 may determine that the purchased article has been consumed. The cooking completion signal may also be the control command execution completion signal.

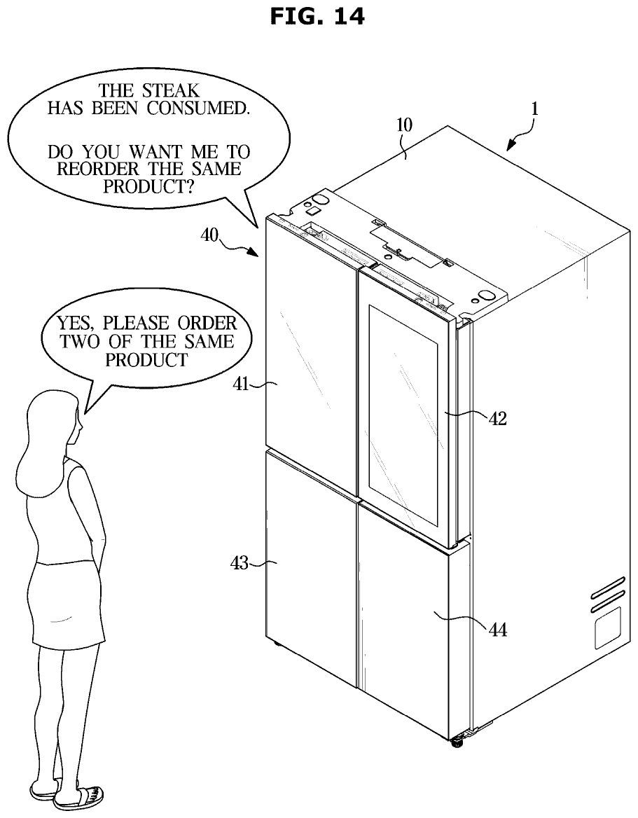

When determining that the purchased article has been consumed, the controller 140 may control the communication module 150 to transmit the purchased article consumption information to the server 3. Additionally, the controller 140 may control the output interface 112 to output a guidance message regarding the repurchase of the purchased article (see FIG. 14).

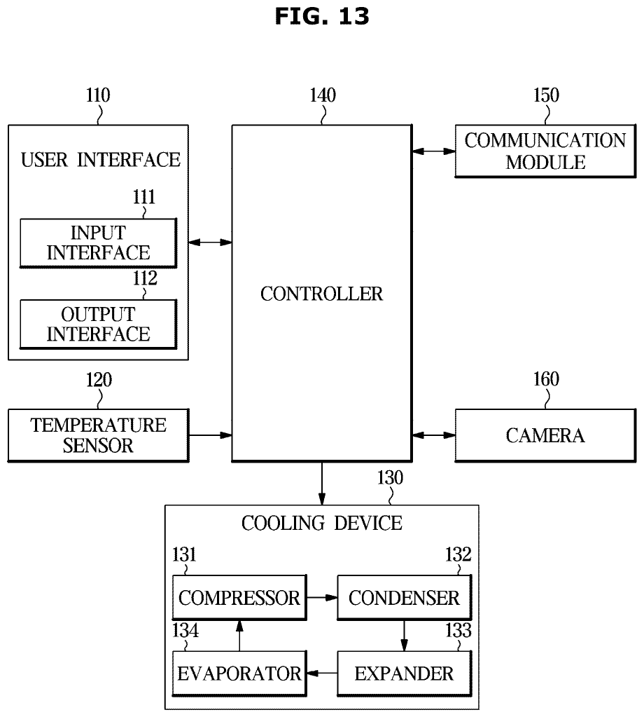

FIG. 13 is a control block diagram of a refrigerator further including a camera according to an embodiment of the disclosure.

FIG. 14 is a view illustrating a guidance message regarding whether to repurchase a purchased article, output from an output interface of a refrigerator according to an embodiment of the disclosure.

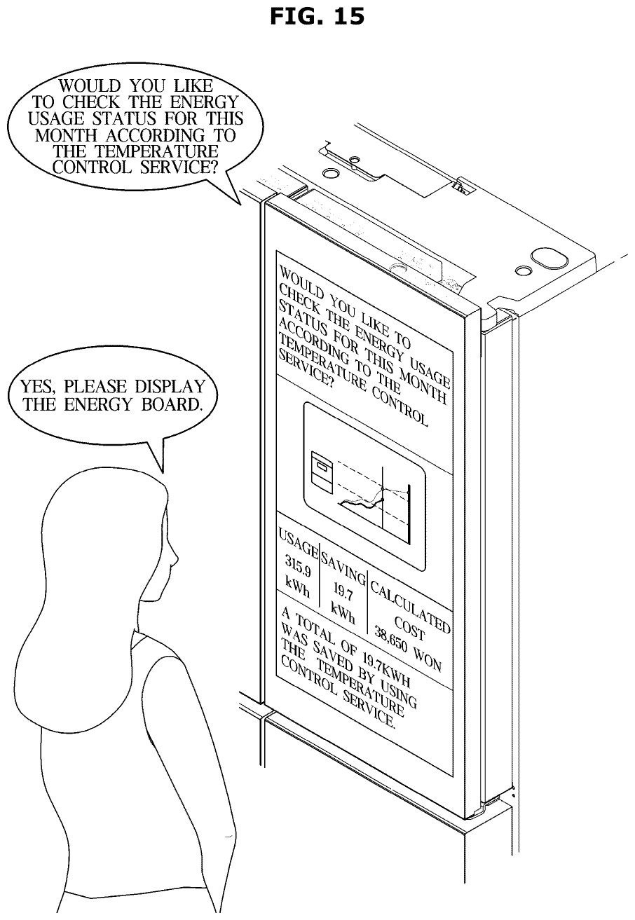

FIG. 15 is a view illustrating a message output from an output interface of a refrigerator based on a user input according to an embodiment of the disclosure.

Referring to FIG. 13, the refrigerator 1 according to an embodiment of the disclosure may further include a camera 160. The camera 160 may be provided in at least one of the plurality of storage rooms 30, 31, 32, and 33.

The controller 140 may process the image captured by the camera 160 to determine whether the purchased article has been consumed. For example, the controller 140 may process the image captured by the camera 160 through image recognition to determine whether the purchased article has been consumed.

When determining that the purchased article has been consumed, the controller 140 may control the communication module 150 to transmit the purchased article consumption information to the server 3. Additionally, the controller 140 may control the output interface 112 to output a guidance message guiding the user to input whether to repurchase the purchased article.

Referring to FIG. 14, a guidance message guiding the user to input whether to repurchase the purchased article may be output through the speaker. As described above, the guidance message may also be output through the display, user device 2, or other means. The user may input whether to repurchase the purchased article through the microphone, user device 2, or other means.

When receiving a repurchase command from the user, the controller 140 may repurchase the purchased article through the server 3.

Referring to FIG. 15, the controller 140 may control the output interface 112 to output a guidance message guiding the user to view the energy usage status according to the controlled temperature based on the product information of the purchased article and the estimated consumption date.

When receiving a command from the user to view the energy usage status, the controller 140 may output information including the power consumption, power savings due to temperature control, and the calculated cost based on the power consumption through the output interface 112.

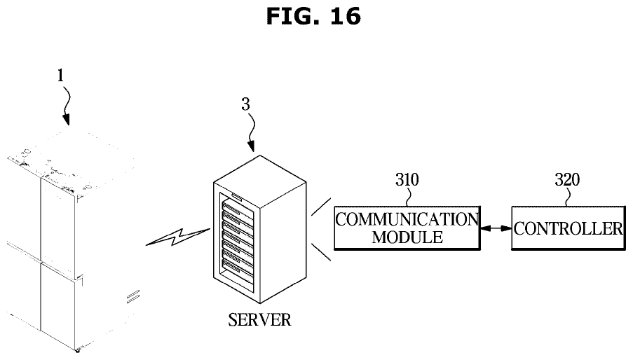

FIG. 16 is a view illustrating a server communicating with a refrigerator according to an embodiment of the disclosure.

Referring to FIG. 16, it is also possible for the refrigerator 1 to communicate with the server 3 through a communication module 310.

A server 3 includes the communication module 310 and a controller 320 that processes the received data.

The communication module 310 may receive the user's purchase history and the product information of the purchased article through the external server 3 and other means. For example, the communication module 310 may receive the user's purchase history and the product information of the purchased article through the user device 2, the user's card company server 3, or the server 3 of the company that sold the article, and may receive the estimated consumption date through the refrigerator 1 and the user device 2. In addition, the communication module 310 may transmit the purchase history and the product information of the purchased article to the refrigerator 1.

The controller 320 may determine the temperature of the storage room where the purchased article is stored based on the product information of the received article and the estimated consumption date of the purchased article input by the user. The controller 320 may control the communication module 310 to transmit a signal for controlling the storage room where the purchased article is stored to the determined temperature.

The communication module 310 may receive a command related to whether to proceed with consumption from the refrigerator 1 or the user device 2.

When receiving a consumption start command, the controller 320 may control the communication module 310 to transmit a signal to the refrigerator 1 to increase the temperature of the storage room where the purchased article is stored and control the temperature of the storage room where the purchased article is stored to the third temperature on the estimated consumption date.

When receiving a consumption cancel command, the controller 320 may control the communication module 310 to transmit a signal to the refrigerator 1 to lower the temperature of the storage room where the purchased article is stored and control the temperature of the storage room where the purchased article is stored to the second temperature.

The communication module 310 may receive a command related to whether to proceed with cooking from the refrigerator 1 or the user device 2.

The controller 320 may determine the home appliance (e.g., an electric oven) for cooking based on the cooking method of the purchased article when receiving a cooking start command, and may transmit a control command to the determined home appliance.

The communication module 310 may receive the purchased article consumption information from the refrigerator 1. In addition, the communication module 310 may receive a cooking completion signal from the household appliance for cooking.

When receiving the purchased article consumption information or the cooking completion signal, the controller 320 may control the communication module 310 to transmit information for the repurchase of the purchased article to at least one of the refrigerator 1 or the user device 2.

The information for the repurchase of the purchased article may include the product name, price fluctuation information of the product, and others.

When receiving a repurchase command from the refrigerator 1 or the user device 2, the controller 320 may repurchase the purchased article through the external server 3.

The operations performed by the controller 320, such as determining the storage room where the purchased article is stored, determining the reference date based on the product information of the purchased article, comparing the reference date and estimated consumption date to set the temperature of the storage room where the purchased article is stored, setting the temperature of the storage room where the purchased article is stored based on whether to proceed with consumption, setting the temperature of the storage room where the purchased article is stored based on the whether to proceed with cooking, and transmitting a control command to the household appliance for cooking, are the same as the operations performed by the controller 140 of the refrigerator 1, as described above.

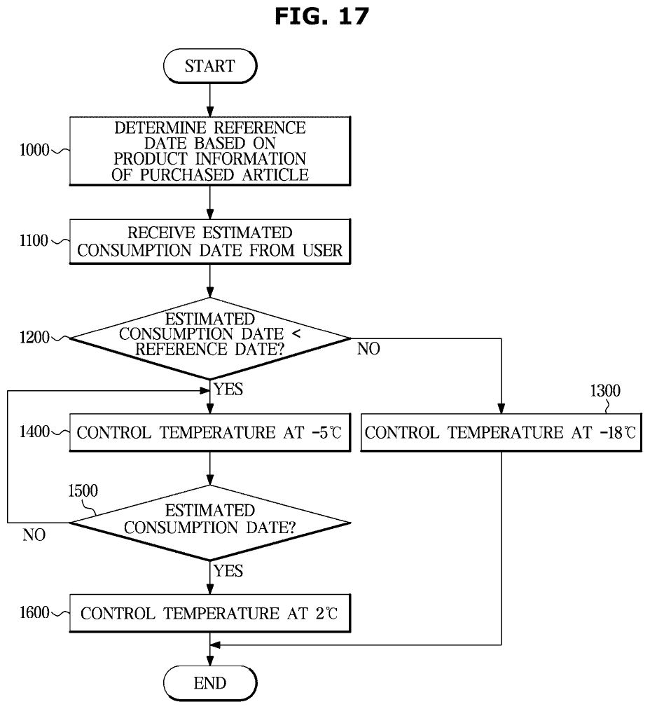

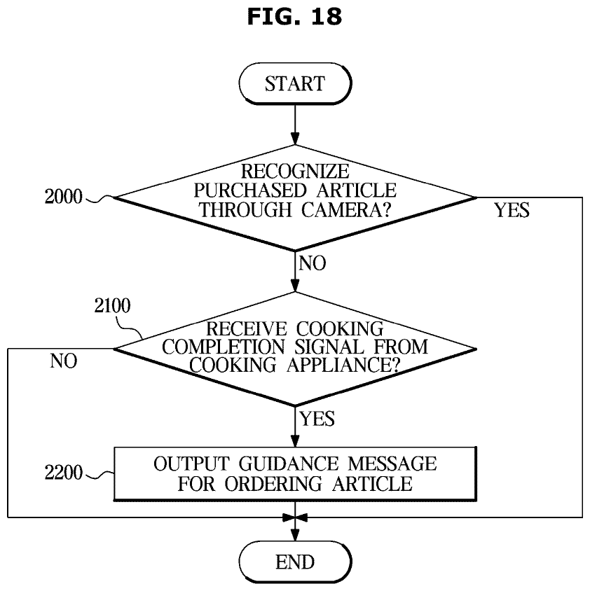

FIGS. 17 and 18 are flowcharts illustrating a method for controlling a refrigerator 1 according to various embodiments of the disclosure.

Referring to FIG. 17, a method for controlling a refrigerator 1 according to an embodiment of the disclosure may determine the reference date based on the product information of the purchased article at operation 1000.

The communication module 150 may receive the purchase history and the product information of the purchased article stored in the application of the server 3 or user device 2 from the server 3 or user device 2. The controller 140 may determine the reference date based on the received product information of the article.

The refrigerator 1 may receive the estimated consumption date from the user at operation 1100. The user may input the estimated consumption date through the user interface 110 or the user device 2.

The controller 140 may compare the reference date and the estimated consumption date to determine whether the estimated consumption date is earlier than the reference date at operation 1200.

When the estimated consumption date is the same as or later than the reference date at operation No in 1200, the controller 140 may control the output interface 112 to output a guidance message for setting the temperature of the storage room where the purchased article is stored, or may control the temperature of the storage room where the purchased article is stored to −18° C. at operation 1300.

When the estimated consumption date is earlier than the reference date, the controller 140 may control the temperature of the storage room where the purchased article is stored to −5° C. at operation 1400.

The controller 140 may determine whether it is the estimated consumption date at operation 1500. According to an embodiment of the disclosure, the controller 140 may control the temperature of the storage room where the purchased article is stored to 2° C. in case of the estimated consumption date.

Referring to FIG. 18, the method for controlling the refrigerator 1 according to an embodiment of the disclosure may recognize the purchased article based on the camera 160 provided in the plurality of storage rooms 30, 31, 32, and 33 at operation 2000.

Specifically, the controller 140 may process the image captured by the camera 160 through image recognition to determine whether the purchased article is recognized. When the article is not recognized, the controller 140 may determine that the article has been consumed at operation No in 2000.

When the article is recognized, the controller 140 terminates the operation because there is no need to repurchase the article at operation Yes in 2000.

The communication module 150 may receive a cooking completion signal from the household appliance for cooking at operation 2100.

When receiving a cooking completion signal from the household appliance for cooking, the controller 140 may determine that the article has been consumed at operation Yes in 2100.

When not receiving a cooking completion signal from the household appliance for cooking, the controller 140 terminates the operation because there is no need to repurchase the article at operation No in 2100.

When determining that the purchased article has been consumed, the controller 140 may control the output interface 112 to output a guidance message for ordering the article at operation 2200.

The determination of whether the purchased article has been consumed is not limited to being based solely on the recognition of the purchased article through the camera 160 or the reception of a signal from the cooking appliance. It may be based on either the recognition of the purchased article through the camera 160 or the reception of a signal from the cooking appliance, and the determination may be made in a different order.

On the other hand, the disclosed embodiments may be implemented in the form of a recording medium that stores computer-executable instructions. The instruction may be stored in the form of a program code. When the instruction is executed by a processor, a program module may be generated, and operations of the disclosed embodiments may be performed. The recording medium may be implemented as a computer-readable recording medium.

Examples of the computer-readable recording medium include all kinds of recording media for storing instructions readable by a computer. Examples of the computer-readable recording medium may include read-only memory (ROM), random-access memory (RAM), magnetic tape, magnetic disc, flash memory, optical data storage device, or the like.

As described above, the disclosed embodiments have been described with reference to the accompanying drawings. A person skilled in the art may understand that the disclosure may be carried out in other forms different from those disclosed in embodiments of the disclosure without changing the technical spirit or the essential features of the disclosure. The disclosed embodiments are illustrative and should not be interpreted as being restrictive.

A refrigerator 1 according to an embodiment includes a main body 10, at least one door 40 provided on a front surface of the main body 10, a plurality of storage rooms 30, 31, 32, and 33 provided on the main body 10 or the at least one door 40 for storing articles, a cooling device 130 for cooling the plurality of storage rooms 30, 31, 32, and 33, a user interface 110 for receiving a user input or outputting information to the user, a communication module 150 for communicating with a server 3 and a user device 2, and a controller 140 that controls the temperature of the storage room where the purchased article is stored based on the product information of the purchased article received from the server 3 and the estimated consumption date of the purchased article input from the user interface 110 or the user device 2. According to this disclosure, the refrigerator 1 may control the temperature of the refrigerator 1 based on the product information of the purchased article and the estimated consumption date of the purchased article, thereby reducing energy consumption.

The controller 140 may determine the reference date based on the product information of the purchased article, and when the estimated consumption date is earlier than the reference date, it may control the temperature of the storage room where the purchased article is stored to a first temperature. When the estimated consumption date is later than or the same as the reference date, it may control the temperature of the storage room where the purchased article is stored to a second temperature lower than the first temperature.

The user interface 110 may output a guidance message regarding whether to proceed with consumption when a preset period has elapsed from the date the estimated consumption date was input. According to this disclosure, by outputting a guidance message regarding whether to proceed with consumption, the purchased article can be managed efficiently.

The controller 140 may control the temperature of the storage room where the purchased article is stored to the first temperature based on a consumption start command received from the user.

The controller 140 may control the temperature of the storage room where the purchased article is stored to a third temperature, which is higher than the first temperature, in case of the estimated consumption date.

The controller 140 may control the temperature of the storage room where the purchased article is stored to the second temperature based on a consumption cancel command received from the user.

The user interface 110 may output a guidance message regarding whether to proceed with cooking the purchased article in case of the estimated consumption date. According to this disclosure, by outputting a guidance message regarding whether to proceed with cooking, the purchased article can be managed efficiently.

The communication module 150 may communicate with a cooking appliance, and the controller 140, based on the cooking start command received from the user, may control the communication module 150 to transmit a control command to the cooking appliance according to the cooking method of the purchased article. According to this disclosure, by controlling the cooking appliance based on the cooking start command, the cooking appliance can be controlled more conveniently.

The controller 140, upon receiving a cooking completion signal from the cooking appliance, may determine that the purchased article has been consumed and control the communication module 150 to transmit information regarding the consumption to the server 3.

The refrigerator further includes at least one camera 160 provided in the storage room where the purchased article is stored, and the controller 140, based on the image captured by the at least one camera 160, may determine whether the purchased article has been consumed. When the purchased article has been consumed, the controller 140 may control the communication module 150 to transmit information regarding the consumption of the purchased article to the server 3.

The user interface 110 may output a guidance message regarding whether to repurchase the purchased article when the purchased article has been consumed. By determining the consumption of purchased articles based on whether they have been cooked or recognized, more accurate determination of consumption can be made.

The server 3 according to an embodiment includes a communication module 310 for communicating with the refrigerator 1 and user device 2, and a controller 320 that determines the temperature of the storage room where the purchased article is stored based on the product information of the purchased article and the estimated consumption date of the purchased article received from the refrigerator 1 or the user device 2, and controls the communication module 150 to transmit a signal to the refrigerator 1 to control the temperature of the storage room where the purchased article is stored to the determined temperature of the storage room. According to this disclosure, the refrigerator 1 may control the temperature of the refrigerator 1 based on the product information of the purchased article and the estimated consumption date of the purchased article, thereby reducing energy consumption.

The controller 320 may control the communication module 150 to transmit a signal to the refrigerator 1 to control the temperature of the storage room where the purchased article is stored, based on whether the purchased article is being consumed, as received from the refrigerator 1 or the user device 2.

The communication module 310 may communicate with a cooking appliance, and the controller 320, based on a cooking start command received from the refrigerator 1 or the user device 2, may control the communication module 150 to transmit a control command to the cooking appliance according to the cooking method of the purchased article.

The controller 320 may control the communication module 150 to transmit information regarding whether to repurchase the purchased article to at least one of the refrigerator 1 or the user device 2, based on at least one of information regarding the purchased article consumption received from the refrigerator 1 or a cooking completion signal received from the cooking appliance.

A method for controlling a refrigerator 1, which includes a plurality of storage rooms 30, 31, 32, 33 and a communication module 150 that communicates with a server 3, includes receiving the product information of a purchased article from the server 3, receiving the estimated consumption date of the purchased article from a user, and controlling the temperature of the storage room where the purchased article is stored based on the product information of the purchased article and the estimated consumption date. According to this disclosure, the refrigerator 1 may control the temperature of the refrigerator 1 based on the product information of the purchased article and the estimated consumption date of the purchased article, thereby reducing energy consumption.

Controlling the temperature of the storage room where the purchased article is stored may include determining a reference date based on the product information of the purchased article, controlling the temperature of the storage room where the purchased article is stored to a first temperature when the estimated consumption date is earlier than the reference date, and controlling the temperature of the storage room where the purchased article is stored to a second temperature lower than the first temperature when the estimated consumption date is later than or the same as the reference date.

The method for controlling the refrigerator 1 according to an embodiment of the disclosure may further include outputting a guidance message regarding whether to proceed with consumption when a preset period has elapsed from the date the estimated consumption date was input.

Controlling the temperature of the storage room where the purchased article is stored may include receiving a command from the user regarding whether to proceed with consumption, and when the consumption start command is received from the user, controlling the temperature of the storage room where the purchased article is stored to the first temperature.

Controlling the temperature of the storage room where the purchased article is stored may include, in case of the estimated consumption date, controlling the temperature of the storage room where the purchased article is stored to a third temperature, which is higher than the first temperature.

Controlling the temperature of the storage room where the purchased article is stored may include receiving a command from the user regarding whether to proceed with consumption, and when the consumption cancel command is received from the user, controlling the temperature of the storage room where the purchased article is stored to the second temperature.

The method for controlling the refrigerator 1 according to an embodiment of the disclosure may further include outputting a guidance message regarding whether to proceed with cooking the purchased article in case of the estimated consumption date.

The method for controlling the refrigerator 1 according to an embodiment of the disclosure may further include receiving a command from the user regarding whether to proceed with cooking, and when the cooking start command is received from the user, transmitting a control command to a cooking appliance based on the cooking method of the purchased article.

The method for controlling the refrigerator 1 according to an embodiment of the disclosure may further include determining that the purchased article has been consumed when a cooking completion signal is received from the cooking appliance, and transmitting information regarding the consumption to the server 3.

The method for controlling the refrigerator 1 according to an embodiment of the disclosure may further include determining whether the purchased article has been consumed based on an image captured by the camera 160, and transmitting information regarding the consumption of the purchased article to the server 3 when the purchased article has been consumed.

The method for controlling the refrigerator 1 according to an embodiment of the disclosure may further include outputting a guidance message regarding whether to repurchase the purchased article when the purchased article has been consumed.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A refrigerator comprising:
a main body;
at least one door provided on a front surface of the main body;
a plurality of storage rooms provided on the main body or the at least one door and configured to store articles;
a cooling device configured to cool the plurality of storage rooms;
a user interface configured to receive a user input from a user or output information to the user;
a communication module configured to communicate with a server and a user device;
memory storing one or more computer programs; and
one or more processors communicatively coupled to the user interface, the communication module, and the memory,
wherein the one or more computer programs include computer-executable instructions that, when executed by the one or more processors individually or collectively, cause the refrigerator to control a temperature of a storage room where a purchased article is stored based on product information of the purchased article received from the server and an estimated consumption date of the purchased article input from the user interface or the user device.

2. The refrigerator of claim 1,
wherein the one or more computer programs further include computer-executable instructions that, when executed by the one or more processors individually or collectively, cause the refrigerator to determine a reference date based on the product information of the purchased article,
wherein, when the estimated consumption date is earlier than the reference date, the one or more computer programs further include computer-executable instructions that, when executed by the one or more processors individually or collectively, cause the refrigerator to control the temperature of the storage room where the purchased article is stored to a first temperature, and
wherein, when the estimated consumption date is later than or the same as the reference date, the one or more computer programs further include computer-executable instructions that, when executed by the one or more processors individually or collectively, cause the refrigerator to control the temperature of the storage room where the purchased article is stored to a second temperature lower than the first temperature.

3. The refrigerator of claim 2, wherein the user interface outputs a guidance message regarding whether to proceed with consumption when a preset period has elapsed from a date of entry of the estimated consumption date.

4. The refrigerator of claim 3, wherein the one or more computer programs further include computer-executable instructions that, when executed by the one or more processors individually or collectively, cause the refrigerator to control the temperature of the storage room where the purchased article is stored to the first temperature based on a consumption start command received from the user.

5. The refrigerator of claim 4, wherein the one or more computer programs further include computer-executable instructions that, when executed by the one or more processors individually or collectively, cause the refrigerator to control the temperature of the storage room where the purchased article is stored to a third temperature, which is higher than the first temperature, in case of the estimated consumption date.

6. The refrigerator of claim 3, wherein the one or more computer programs further include computer-executable instructions that, when executed by the one or more processors individually or collectively, cause the refrigerator to control the temperature of the storage room where the purchased article is stored to the second temperature based on a consumption cancel command received from the user.

7. The refrigerator of claim 1, wherein the user interface outputs a guidance message regarding whether to proceed with cooking the purchased article in case of the estimated consumption date.

8. The refrigerator of claim 7,
wherein the communication module communicates with a cooking appliance, and
wherein the one or more computer programs further include computer-executable instructions that, when executed by the one or more processors individually or collectively, cause the refrigerator to control the communication module to transmit a control command according to a cooking method of the purchased article to the cooking appliance, based on a cooking start command received from the user.

9. The refrigerator of claim 8, wherein, upon receiving a cooking completion signal from the cooking appliance, the one or more computer programs further include computer-executable instructions that, when executed by the one or more processors individually or collectively, cause the refrigerator to determine that the purchased article has been consumed and controls the communication module to transmit information regarding the consumption to the server.

10. The refrigerator of claim 1, further comprising:
at least one camera provided in the storage room where the purchased article is stored,
wherein the one or more computer programs further include computer-executable instructions that, when executed by the one or more processors individually or collectively, cause the refrigerator to determine whether the purchased article has been consumed based on an image captured by the at least one camera, and
wherein, when the purchased article has been consumed, the one or more computer programs further include computer-executable instructions that, when executed by the one or more processors individually or collectively, cause the refrigerator to control the communication module to transmit information regarding the consumption of the purchased article to the server.

11. The refrigerator of claim 9, wherein the user interface outputs a guidance message regarding whether to repurchase the purchased article when the purchased article has been consumed.

12. A server comprising:
a communication module configured to communicate with a refrigerator and a user device;
memory storing one or more computer programs; and
one or more processors communicatively coupled to the communication module and the memory,
wherein the one or more computer programs include computer-executable instructions that, when executed by the one or more processors individually or collectively, cause the server to:
determine a temperature of a storage room where a purchased article is stored based on product information of the purchased article and an estimated consumption date of the purchased article received from the refrigerator or the user device, and
control the communication module to transmit a signal to control the temperature of the storage room where the purchased article is stored to the determined temperature of the storage room to the refrigerator.

13. The server of claim 12, wherein the one or more computer programs further include computer-executable instructions that, when executed by the one or more processors individually or collectively, cause the server to control the communication module to transmit a signal to the refrigerator to control the temperature of the storage room where the purchased article is stored, based on whether the purchased article is being consumed, as received from the refrigerator or the user device.

14. The server of claim 12,
wherein the communication module communicates with a cooking appliance, and
wherein the one or more computer programs further include computer-executable instructions that, when executed by the one or more processors individually or collectively, cause the server to control the communication module to transmit a control command according to a cooking method of the purchased article to the cooking appliance, based on a cooking start command received from the refrigerator or the user device.

15. The server of claim 12, wherein the one or more computer programs further include computer-executable instructions that, when executed by the one or more processors individually or collectively, cause the server to control the communication module to transmit information regarding whether to repurchase the purchased article to at least one of the refrigerator or the user device, based on at least one of information regarding the purchased article consumption received from the refrigerator or a cooking completion signal received from a cooking appliance.

16. A method for controlling a refrigerator, which includes a plurality of storage rooms and a communication module that communicates with a server, the method comprising:
receiving product information of a purchased article from the server;
receiving an estimated consumption date of the purchased article from a user; and
controlling a temperature of the storage room where the purchased article is stored based on the product information of the purchased article and the estimated consumption date.

17. The method of claim 16, further comprising:
determining a reference date based on the product information of the purchased article;
controlling the temperature of the storage room where the purchased article is stored to a first temperature when the estimated consumption date is earlier than the reference date; and
controlling the temperature of the storage room where the purchased article is stored to a second temperature lower than the first temperature when the estimated consumption date is later than or same as the reference date.

18. The method of claim 17, further comprising:
outputting a guidance message regarding whether to proceed with consumption when a preset period has elapsed from the date the estimated consumption date was input.

19. The method of claim 18, further comprising:
receiving a command from the user regarding whether to proceed with consumption; and
when the consumption start command is received from the user, controlling the temperature of the storage room where the purchased article is stored to the first temperature.

20. The method of claim 19, further comprising:
in case of the estimated consumption date, controlling the temperature of the storage room where the purchased article is stored to a third temperature, which is higher than the first temperature.
